(19) United States
(12) Patent Application Publication
(10) Pub. No.: US 2024/0175846 A1
(43) Pub. Date: May 30, 2024

(54) Differential Mobility Spectrometer/Mass Spectrometer Interface With Greater Than 10 L/Min Transport Gas Flow

(71) Applicant: DH Technologies Development Pte. Ltd., Singapore (SG)

(72) Inventors: Thomas COVEY, Concord (CA); Yang KANG, Richmond Hill (CA); Bradley B. SCHNEIDER, Bradford (CA)

(73) Assignee: DH Technologies Development Pte. Ltd., Singapore (SG)

(21) Appl. No.: 18/283,318

(22) PCT Filed: Mar. 22, 2022
(86) PCT No.: PCT/IB2022/052625

§ 371 Date: Sep. 21, 2023

Related U.S. Application Data
(60) Provisional application No. 63/164,727, filed on Mar. 23, 2021.

(51) Int. Cl. G01N 27/624; G01N 27/623; H01J 49/24

(52) U.S. Cl. CPC G01N 27/624; G01N 27/623; H01J 49/24

(57) ABSTRACT

Methods and systems for performing differential mobility spectrometry are provided herein. Systems and methods in accordance with various aspects of the present teachings provide differential mobility separation at drift gas volumetric flow rates greater than about 10 L/min, which are substantially higher than those previously reported and conventionally used in DMS-based analyses.

### RELATED APPLICATIONS

This application claims priority to U.S. Provisional Application No. 63/164,727 filed on Mar. 23, 2021, the contents of which are incorporated herein in their entirety.

### FIELD

The present teachings generally relate to methods and systems of introducing ions into a differential mobility spectrometer (DMS) that may be coupled to a mass spectrometer.

### BACKGROUND

Mass spectrometry (MS) is a powerful analytical technique for determining the elemental composition of test substances with both qualitative and quantitative applications. In a typical MS workflow, a sample is converted into ions, which can then be separated by electric and/or magnetic fields due to differences in the ions' mass-to-charge ratios. To avoid undesirable collisions between ions and background molecules (and thus possible fragmentation of the ions), high-resolution MS typically transports these ions through multiple stages having decreasing operating pressure, with the final stage often as low as 10⁻⁵ Torr or lower.

Whereas MS separates ions based on their mass-to-charge ratios at very low operating pressures, ion mobility based analytical techniques instead separate and analyze ions based upon differences in their mobility through a relatively high pressure gas. One example of such techniques utilizes an ion mobility spectrometer (IMS) in which ion separation occurs on the basis of the ion species' cross section while being subjected to a constant electric field. As the ions are transported through the drift region of the IMS, ion species exhibit specific interactions with drift gas molecules due to the ion species' characteristic collision cross section, thereby resulting in different drift velocities, and ultimately, detectable differences in drift times for each of the various ion species. Another known ion mobility based technique is differential mobility spectrometry in which a differential mobility spectrometer (DMS) separates ions on the basis of the alpha parameter, which is related to the differences in the ion mobility coefficient in varying strengths of electric field. In a DMS, RF voltages, often referred to as separation voltages (SV), are applied across the drift tube in a direction perpendicular to that of the drift gas flow. Ions of a given species tend to migrate radially away from the axis of the transport chamber by a characteristic amount during each cycle of the RF waveform due to differences in mobility during the high field and low field portions. A DC potential, commonly referred to as a compensation voltage (CoV), is applied to the DMS and provides a counterbalancing electrostatic force to that of the SV. The CoV can be tuned so as to preferentially prevent the drift of one or more species of ions of interest. Depending on the application, the CoV can be set to a fixed value to pass only ion species with a particular differential mobility while the remaining species of ions drift toward the electrodes and are neutralized. Alternatively, if the CoV is scanned for a fixed SV as a sample is introduced continuously into the DMS, a mobility spectrum can be produced as the DMS transmits ions of different differential mobilities. Examples of known differential mobility spectrometers are described in U.S. Pat. Nos. 8,084,736 and 9,835,588, the teachings of which are hereby incorporated by reference in their entireties.

While ion mobility techniques may be used on their own to analyze a sample, a DMS may also be interfaced with a mass spectrometer to serve as a front end orthogonal separation method and provide enhanced efficiency and/or analytical power to the DMS-MS system. For example, whereas chromatographic separation in in-line LC-MS typically requires several minutes as the various species of analytes differentially elute from the LC column and the eluate is transported to the ion source, DMS separation of a sample may be performed in less than a second, for example. This DMS-MS combination takes advantage of the atmospheric pressure, gas phase, and continuous ion separation capabilities of the DMS and may enhance numerous areas of sample analysis, including proteomics, peptide/protein conformation, pharmacokinetic, metabolism analysis, trace level explosives detection, and petroleum monitoring, all by way of non-limiting example.

There remains a need for improved methods and systems for utilizing differential mobility spectrometry prior to mass spectrometry.

### SUMMARY

The present teachings are directed to improved methods and systems for differential mobility spectrometry.

Conventional methods and systems generally adjust the residence time of ions within the DMS in order to enhance either the selectivity or the sensitivity of the DMS analysis. Sensitivity is related to the transmission efficiency of the DMS (e.g., the percentage of ions of interest that are transmitted by the DMS for detection or further analysis), while selectivity refers to the ability of the DMS to distinguish between or resolve different ion species. As described in U.S. Pat. No. 8,084,736, it has been observed that increasing the residence time of ions in the DMS tends to increase the resolution of ion species' separation by exposing the ions in the drift gas to the DMS electric fields for a longer duration. However, it is also conventionally recognized that such improved selectivity comes at a cost as the increased residence time results in reduced transmission efficiency due to the neutralization of both desired and undesired ions on the DMS electrodes. In light of this tradeoff, various techniques have been developed to allow a user to “tune” a DMS according to the desired combination of resolution and transmission efficiency. By way of example, the aforementioned U.S. Pat. No. 8,084,736 discloses the use of a “throttle gas,” which may be provided between the DMS and a downstream detector or mass spectrometer to throttle back or slow the flow of the drift gas through the DMS when increased resolution is desired: “In some embodiments it can therefore be desirable to be able to precisely control the amount of throttle gas that is added . . . to provide a degree of control to the gas flow rate through the differential mobility spectrometer [ ], thereby controlling the tradeoff between sensitivity and selectivity.” Col. 5, ll. 26-32. Another known device described in U.S. Pat. No. 9,835,588 provides an adjustable jet injector inlet in which the inlet's aperture size controls the residence time, and thus, the tradeoff between selectivity and transmission efficiency: “finite control can be maintained between resolution and sensitivity in an analogous fashion to what is achieved for example in U.S. Pat. No. 8,084,736 . . . without requiring the need to provide additional gas flows (such as throttle gases) or suction/vacuum.”

Whereas conventional DMS-based systems and methods like those described above may require choosing between conflicting goals of enhanced resolution and increased transmission when adjusting residence time within the DMS, the inventors of the present teachings have surprisingly discovered that resolution of a DMS can be enhanced without substantially decreasing transmission efficiency by operating at drift gas flow rates that are substantially higher than those previously reported and conventionally used (and without the use of throttle gas). In this manner and contrary to conventional knowledge, a DMS in accordance with the present teachings may thus be switched between an “ion scrubber” mode that transmits a wide range of ions of interest with minimal losses (while unwanted ions are blocked) and a “high resolution” mode in which one or more particular species of ions of interest may exhibit relatively narrow mobility peak widths without substantial effects on the transmission efficiency as the peak resolution increases.

In accordance with various aspects of the present teachings, a method of analyzing ions in a differential mobility spectrometer is provided, the method comprising introducing a drift gas at a flow rate greater than about 10 L/min through an inlet of a differential mobility spectrometer and performing differential mobility separation on ions within the drift gas using the differential mobility spectrometer as the drift gas transports the ions therethrough. In various aspects, the method may further comprise adjusting a resolution of the differential mobility separation for at least one species of ion of interest without substantially adjusting transmission of said at least one species of ion of interest.

In various related aspects, the flow rate of the drift gas through the inlet may be substantially maintained during said adjusting step. Additionally, in some aspects, a throttle gas not only need not, but is not provided to an outlet of said differential mobility spectrometer during said adjusting step.

In certain aspects, the resolution may be adjusted by adjusting a residence time of the ions within the differential mobility spectrometer. By way of example, the method may comprise adjusting a cross-sectional area of the inlet to adjust a residence time of ions within the differential mobility spectrometer. In certain aspects, decreasing the cross-sectional area of the inlet may be effective to decrease the residence time of ions within the differential mobility spectrometer, while increasing the cross-sectional area of the inlet may be effective to increase the residence time of ions within the differential mobility spectrometer.

The inlet may be adjusted to a variety of sizes in accordance with the present teachings, depending, for example, on the size of the DMS (e.g., the size of the analytical gap, the geometry of the electrodes, the mobility of the ion species of interest). In some example aspects, a diameter of the inlet may be adjustable between about 0.5 mm and about 20 mm. For example, the inlet may be adjusted to exhibit a diameter greater than about 3.5 mm. In some aspects, the inlet may be adjusted to a diameter of about 5 mm. In various example aspects, the differential mobility spectrometer may comprise parallel plate electrodes separated by an analytical gap, wherein the inlet is adjustable to exhibit an area substantially equal to the cross-sectional area of the analytical gap.

As noted above, the volumetric flow rate of the drift gas through the inlet of the DMS may be greater than about 10 L/min. In various aspects, a drift gas supply can be provided to supply a drift gas to the inlet of the DMS such that the volumetric flow rate is in a range of about 10 L/min to about 30 L/min (e.g., about 16 L/min).

In various aspects, ions separated by the DMS can be detected directly (e.g., by a detector at the outlet of the DMS) or may be subject to further analysis. By way of example, mass spectrometry may be performed on ions transmitted through the outlet of the differential mobility spectrometer and into an inlet of a mass spectrometer.

In accordance with various aspects of the present teachings, a system for performing differential mobility spectrometry is provided, the system comprising a housing having an inlet and an outlet. At least two parallel plate electrodes may be disposed within the housing and may be separated from one another by a fixed distance, with the volume between the two electrodes defining an analytical gap through which ions are transported from the inlet toward the outlet. A voltage source may provide RF and DC voltages to at least one of the parallel plate electrodes to generate an electric field, wherein the electric field may pass through selected ions species based on mobility characteristics. The system may further comprise a drift gas supply for supplying a gas that flows through the inlet at a flow rate greater than about 10 L/min.

In various aspects, the inlet may comprise an aperture for allowing the traversal of the drift gas into the housing. In certain aspects, the size of the aperture may be selected, for example, by replacing an inlet having a fixed size aperture with another inlet having a different size aperture. Additionally or alternatively, the cross-sectional area of an aperture may be adjustable. For example, the aperture may be adjusted to exhibit an area substantially equal to the cross-sectional area of the analytical gap. In various aspects, the cross-sectional area of the aperture can be adjusted to be smaller than, greater than, or equivalent to the cross-sectional area of the analytical gap. In various aspects, a diameter of the inlet may be adjustable between about 0.5 mm and about 20 mm. For example, the inlet may be adjusted to exhibit a diameter greater than about 3.5 mm. In some aspects, the inlet may be adjusted to a diameter of about 5 mm.

In certain aspects, the aperture may extend through at least one electrode plate, wherein the at least one electrode plate is electrically separated from the parallel plate electrodes. In certain aspects, the electrode plate may be replaced, for example, if a different sized aperture is desired.

As discussed herein, certain aspects of the present teachings provide that the resolution of the differential mobility separation for at least one species of ion of interest may be adjusted without substantially adjusting transmission of said at least one species of ion of interest. In certain aspects, the system may maintain the volumetric flow rate of the drift gas through the inlet substantially constant although the linear velocity of the ions within the DMS may be increased or decreased, for example, depending on the size of the inlet to the DMS. In such aspects, residence time may be varied without the use of a throttle gas, for example. Accordingly, in certain aspects, a throttle gas supply is not provided for adding a throttle gas to the outlet of the housing. In other embodiments, the inlet aperture may be kept constant and the transport gas flow rate may be adjusted by providing a throttle gas to reduce the volumetric flow of transport gas.

The DMS can have a variety of configurations and sizes. As noted above, for example, the DMS can comprise at least two parallel plate electrodes separated from one another by a fixed distance along their length. In certain aspects, the cross-sectional area of the analytical gap may be about 20 mm². Additionally or alternatively, in certain aspects, a length of the analytical gap along the direction of drift gas flow may be greater than about 30 mm (e.g., about 60 mm).

In various aspects, the outlet of the housing may be sealed to an inlet of a vacuum chamber containing at least one mass spectrometer. In various embodiments, an additional throttle gas chamber may be provided between the differential mobility spectrometer and the mass spectrometer inlet. In related aspects, gas may be added or removed from the throttle gas chamber to change the volumetric flow rate through the differential mobility spectrometer.

These and other features of the applicant's teachings are set forth herein.

### BRIEF DESCRIPTION OF THE DRAWINGS

The skilled person in the art will understand that the drawings, described below, are for illustration purposes only. The drawings are not intended to limit the scope of the applicant's teachings in any way.

FIG. 1 is a schematic representation of an exemplary differential mobility spectrometer in accordance with an aspect of various embodiments of the applicant's teachings.

FIG. 2 is a schematic representation of another exemplary differential mobility spectrometer in accordance with an aspect of various embodiments of the applicant's teachings.

FIG. 3 depicts the performance of a differential mobility system like that of FIG. 2 with variously-sized inlet apertures.

FIG. 4 depicts the average ion transmission of various compounds transported through a differential mobility system like that of FIG. 2 with variously-sized inlet apertures and under various drift gas volumetric flow rate conditions.

FIG. 5 depicts the results of FIG. 4 for the compound reserpine.

FIG. 6 depicts the peak width (indicative of resolution) of various compounds transported through a differential mobility system like that of FIG. 2 at a drift gas flow rate of 16 L/min with variously-sized inlet apertures.

FIG. 7 depicts the intensity (indicative of sensitivity) of various compounds transported through a differential mobility system like that of FIG. 2 at a drift gas flow rate of 16 L/min with variously-sized inlet apertures.

### DETAILED DESCRIPTION

It will be appreciated that for clarity, the following discussion will explicate various aspects of embodiments of the applicant's teachings, while omitting certain specific details wherever convenient or appropriate to do so. For example, discussion of like or analogous features in alternative embodiments may be somewhat abbreviated. Well-known ideas or concepts may also for brevity not be discussed in any great detail. The skilled person will recognize that some embodiments of the applicant's teachings may not require certain of the specifically described details in every implementation, which are set forth herein only to provide a thorough understanding of the embodiments. Similarly, it will be apparent that the described embodiments may be susceptible to alteration or variation according to common general knowledge without departing from the scope of the disclosure. The following detailed description of embodiments is not to be regarded as limiting the scope of the applicant's teachings in any manner.

As used herein, the terms “about” and “substantially equal” refer to variations in a numerical quantity that can occur, for example, through measuring or handling procedures in the real world; through inadvertent error in these procedures; through differences in the manufacture, source, or purity of compositions or reagents; and the like. Typically, the terms “about” and “substantially” as used herein mean 10% greater or lesser than the value or range of values stated or the complete condition or state. For instance, a concentration value of about 30% or substantially equal to 30% can mean a concentration between 27% and 33%. The terms also refer to variations that would be recognized by one skilled in the art as being equivalent so long as such variations do not encompass known values practiced by the prior art.

Systems and methods in accordance with various aspects of the present teachings provide differential mobility separation at drift gas volumetric flow rates greater than about 10 L/min, which are substantially higher than those previously reported and conventionally used in DMS-based analyses. Moreover, whereas conventional differential mobility analysis must generally accept one of reduced sensitivity or selectivity when enhancing the other, systems and methods in accordance with various aspects of the present teachings can unexpectedly increase resolution of DMS-based analysis without substantial sacrifices in transmission efficiency at drift gas volumetric flow rates greater than about 10 L/min. By operating at such elevated drift gas flow rates, systems and methods in accordance with the present teachings are surprisingly able to increase the residence time of ions of interest in the DMS (and even without the use of a throttle gas) without substantial loss of the desired ions through neutralization at the DMS electrodes.

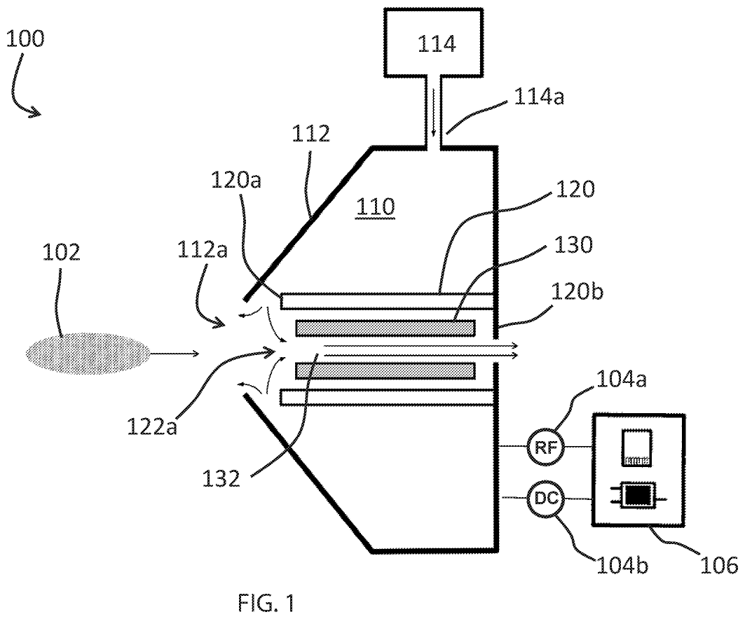

FIG. 1 schematically depicts an embodiment of an exemplary system 100 for performing differential mobility spectrometry in accordance with various aspects of the applicant's teachings. As shown, the system 100 comprises a housing 120 that surrounds two parallel electrodes 130 that are separated by a fixed distance to define an analytical gap 132 therebetween. The housing 120 has an inlet 120a and an outlet 120b such that ions 102 can enter the inlet 120a, flow through the analytical gap 132 between the electrodes 130, and exit the outlet 120b. Though not shown in FIG. 1, the outlet 120b can be sealed, for example, to a downstream vacuum chamber that houses a detector for directly detecting the ion species transmitted through the outlet 120b or one or more mass analyzer elements for further processing of the transmitted ions (e.g., mass analyzing). In this manner, differential mobility separation may be performed on ions 102 transported within the drift gas flowing through the analytical gap 132 at volumetric flow rates at 10 L/min or greater, which is substantially higher than those flow rates previously reported for DMS-based analyses.

The electrodes 130 can have a variety of sizes and configurations, but as shown are generally separated by a fixed distance so as to define an analytical gap 132 having a constant cross-sectional size and shape along its length. By way of non-limiting example, the analytical gap 132 can exhibit a height (i.e., distance between the electrodes 132) of at least 0.25 mm (e.g., about 1 mm), a width of at least 5 mm (e.g., about 20 mm) and a length greater than about 30 mm (e.g., about 60 mm). The analytical gap 132 may therefor exhibit a cross-sectional area that is normal to the direction of drift gas flow in a range of about 1.25 mm² to greater than 20 mm² and a volume in a range of about 37.5 mm³ to greater than 1200 mm³, all by way of non-limiting example.

The inlet 120a of the housing 120 can also have a variety of sizes and configurations, but as shown in FIG. 1 generally provides an aperture 122a through which ions 102 can enter the analytical gap 132. In accordance with various aspects of the present teachings, the aperture through which ions 102 pass into the housing may be circular, slit-shaped or any other suitable shape that may be the same or different from the cross-sectional shape of the analytical gap 132. Though the aperture 122a may exhibit a variable size as discussed below, the example inlet 120a depicted in FIG. 1 may comprise a circular aperture 122a of fixed cross-sectional size through which at least 10 L/min of drift gas can flow therethrough. By way of non-limiting example, the circular aperture 122a may have a diameter in the range between about 0.5 mm and greater than 5 mm, which represents an area of about 0.8 mm² to greater than 20 mm², and which may be smaller, equal to, or greater the cross-sectional area of the analytical gap 132. Non-circular apertures can likewise exhibit similar areas. In some particular aspects, the circular aperture 122a may exhibit a diameter greater than 3.5 mm, which is used in conventional DMS systems. For example, U.S. Pat. No. 9,835,588 suggests that transmission efficiency continually decreases as apertures expanded beyond 2.25 mm in diameter at volumetric flow rates of drift gas substantially below the about 10 L/min as described in accordance with the present teachings. It will be apparent to those of skill in the relevant arts that housing 120 may be comprised of an insulating material such as ceramics, while the inlet 120a (or a portion thereof surrounding the aperture 122a) will be a conductive material such as various metals or ceramic with a conductive coating. The aperture 122a may be formed in a lens which can be braised onto housing 120, by way of non-limiting example.

Ions passing through the analytical gap 132 are subjected to varying electric fields generated by the electrodes 130, which can be coupled to one or more power supplies 104a,b operating under the control of a controller 106 for supplying a separation voltage (SV) and compensation voltage (CoV) to the electrodes 130. While the electrodes 130 are described herein using the same identifier (130), it will be appreciated that the electrodes can be configured so that separate RF and/or DC potentials can be transmitted separately to each of the two electrodes so that the pair of electrodes operate individually as distinct electrodes. Further, a skilled artisan would appreciate that the SV and CoV can separate ions having differing ion mobility properties as the ions traverse through the analytical gap 132 along the length of the electrodes 130. For example, the SV, which may be an asymmetric RF voltage applied to the electrodes 130 generates an electric field across the analytical gap 132 in a direction perpendicular to that of the drift gas flow. Due to differences in the mobility of different ion species during the high field and low field portions of the SV, ions of a given species tend to migrate toward or away from the electrodes 130 by a characteristic amount during each cycle of the RF waveform. The CoV, which may be a DC potential, is applied to the DMS and may provide a counterbalancing electrostatic force to that of the SV. The CoV can be tuned so as to preferentially restore a stable trajectory to particular ions such that they will traverse the entire length of the analytical gap 132 and exit the outlet 120b. Depending on the application, the CoV can be set to a fixed value such that one or more species within a particular differential mobility range can traverse the analytical gap 132 and exit the outlet 120b without being neutralized on the electrodes 130. It will also be appreciated that if the CoV is scanned for a fixed SV as ions 102 are introduced continuously through the housing inlet 120a, a mobility spectrum can be generated as ions of different differential mobilities traverse the length of the analytical gap 132. As will be appreciated by a person skilled in the art, a differential mobility spectrometer can also be controlled to operate in “transparent” mode, for example, by setting SV and CoV to zero such that substantially all ions are transmitted therethrough without experiencing a net radial force.

As shown, the housing 120 is disposed within a curtain chamber 110, which is defined by a curtain plate 112. The curtain plate 112 contains an opening 112a in communication with the entrance of the housing 120. A curtain gas supply 114 is fluidly connected to the curtain chamber 110 by conduit 114a and supplies curtain gas to the curtain chamber 110. As indicated by the arrows of FIG. 1, the pressure of the curtain gases in the curtain chamber 110 can provide both a curtain gas outflow out of the opening 112a, as well as a curtain gas inflow into the inlet 120a of the housing 120, which inflow becomes the drift gas that carries the ions 102 through the analytical gap 132 to the outlet 120b. In some aspects, a voltage can be applied to the curtain plate 112 from a suitable source to propel the ions 102 across the gap between the curtain plate 112 and the inlet 120a to the housing 120. Upon entering the housing 120, the ions 102 are swept along in the drift gas, and the asymmetric voltages applied to the parallel electrodes 130 cause separation of ions based on ion mobility properties. The ions 102 and drift gas continue to travel down the analytical gap 132 to the outlet 120b where the ions may be subjected to further processing. Exemplary examples of such devices include a detector, a mass filter, a mass spectrometer, other types of spectrometers such as Raman or IR and other mobility-based devices such as another DMS system, a high field asymmetric waveform ion mobility spectrometer and an ion mobility spectrometer device.

In accordance with various aspects of the present teachings, the curtain gas supply 114 can supply curtain gas at a selected pressure and/or volumetric flow rate such that the drift gas flow through the analytical gap 132 can be maintained at a volumetric flow rate greater than about 10 L/min (e.g., in a range of about 10 L/min to about 30 L/min, about 16 L/min), which as noted above is substantially higher than those previously reported and conventionally used for DMS-based analysis. As shown, the housing 120 is configured such that curtain gas can only enter and flow past the parallel electrodes 130 by way of the housing inlet 120a and can only exit the housing 120 by way of the housing outlet 120b. As discussed otherwise herein, the outlet 120b of the housing 120 may be sealed to a relatively low pressure region (e.g., a vacuum chamber, not shown in FIG. 1) such that suction from this low pressure region is effective to assist in dragging the drift gas into the housing 120 and through the analytical gap 132 at the elevated volumetric flow rates discussed herein. For example, outlet 120b may be the vacuum inlet of a mass spectrometer. In such instances, the pressure of the curtain gases in the curtain chamber 110 can be maintained at or near atmospheric pressure (e.g., ˜760 Torr) while the vacuum chamber can be maintained at a pressure of less than 30 Torr, or by way of non-limiting example, a pressure of approximately 6 Torr. It will also be apparent to those of skill in the relevant arts that when the DMS system 100 includes a mass spectrometer downstream of outlet 120b, an additional throttle gas chamber may be included between the outlet 120b of the DMS electrodes 130 and the MS inlet as described, for example, in U.S. Pat. Nos. 8,084,736, 8,513,600, and 9,171,711, all of which are incorporated herein by reference. By way of example, gas may be added (e.g., via throttle gas supply) or removed from the throttle gas chamber to change the volumetric flow rate through the electrodes 130. Additionally or alternatively, it will be appreciated that the pressure in the region prior to the inlet 120a can be increased to cause the drift gas to be “pushed” through the analytical gap 132 at the elevated volumetric flow rates discussed herein, rather than being “pulled” from the outlet 120b. By way of non-limiting example, the pressure in the region prior to the inlet 120a can be greater than 760 Torr.

It will be appreciated by a person skilled in the art that the curtain gas supply 114 can provide any pure or mixed composition curtain gas to the curtain gas chamber 110 via curtain gas conduit 114a at flow rates determined by a flow controller and valves, for example. By way of non-limiting example, the curtain gas can be air, O₂, He, N₂, CO₂, SF₆, or any combination thereof. Moreover, the system 100 can also include a modifier supply (not shown) for supplying a modifier reagent to the curtain gas, which modifier reagent may cause the ions to cluster differentially during the high and low field portions of the SV. As will be appreciated by a person skilled in the art, the modifier supply can be a reservoir of a solid, liquid, or gas through which the curtain gas is delivered to the curtain chamber 110. By way of example, the curtain gas can be bubbled through a liquid modifier supply. Alternatively, a modifier liquid or gas can be metered into the curtain gas, for example, through an LC pump, syringe pump, or other dispensing device for dispensing the modifier into the curtain gas at a known rate. For example, the modifier can be introduced using a pump so as to provide a selected concentration of the modifier in the curtain gas. The modifier supply can provide any modifier including, by way of non-limiting example, acetone, acetonitrile, ethyl acetate, water, methanol, isopropanol, methylene chloride, methylene bromide, or any combination thereof. Optionally, the curtain gas conduit 114a and/or curtain chamber 110 can include a heater (not shown) for heating the mixture of the curtain gas and the modifier to further control the proportion of modifier in the curtain gas. As the curtain gas within the curtain chamber 110 can include a modifier, the drift gas transported through the housing 120 can also comprise a modifier.

Ions 102 can be provided from an ion source and emitted into the curtain chamber 110 via curtain chamber inlet 112a. As will be appreciated by a person skilled in the art, the ion source can be virtually any ion source known in the art, including for example, a continuous ion source, a pulsed ion source, an atmospheric pressure chemical ionization (APCI) source, an electrospray ionization (ESI) source, an inductively coupled plasma (ICP) ion source, a matrix-assisted laser desorption/ionization (MALDI) ion source, a glow discharge ion source, an electron impact ion source, a chemical ionization source, or a photoionization ion source, among others.

As noted above, the exemplary system 100 can additionally comprise a controller 106 for controlling operation thereof. By way of example, the controller 106 can include a processor for processing information. Controller 106 also includes data storage (not shown) for storing data (e.g., in a database or library) and instructions to be executed by processor, etc. Data storage (not shown) also may be used for storing temporary variables or other intermediate information during execution of instructions to be executed by the processor.

The controller 106 can also be operatively associated with an output device such as a display (e.g., a cathode ray tube (CRT) or liquid crystal display (LCD), for displaying information to a computer user) and/or an input device including alphanumeric and other keys and/or cursor control, for communicating information and command selections to the processor. Consistent with certain implementations of the present teachings, the controller 106 can execute one or more sequences of one or more instructions contained in data storage (not shown), for example, or read into memory from another computer-readable medium, such as a storage device (e.g., a disk). Implementations of the present teachings are not limited to any specific combination of hardware circuitry and software.

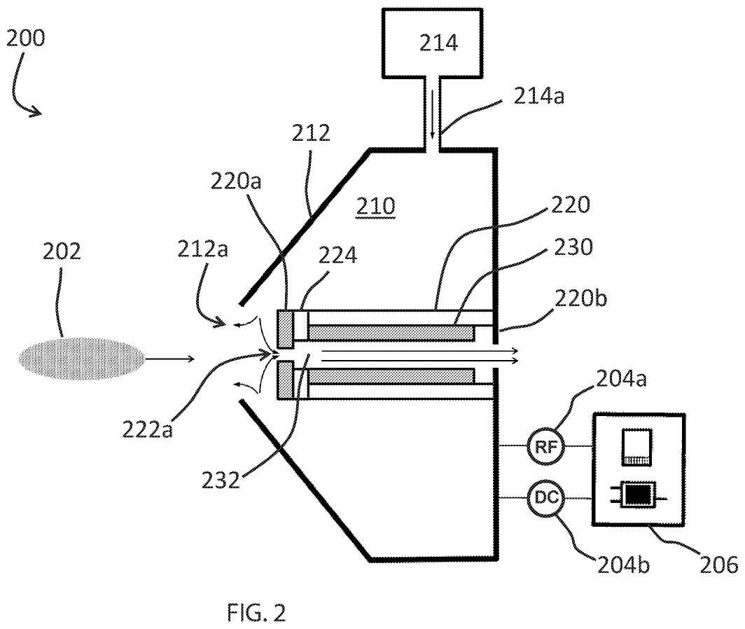

With reference now to FIG. 2, another exemplary system 200 in accordance with various aspects of the present teachings is depicted. The system 200 is similar to the system 100 of FIG. 1 (with like elements having like identifiers), but differs in that the inlet of the housing 220 comprises a jet injector electrode 220a through which the inlet aperture 222a extends. As shown in FIG. 2, the conductive jet injector electrode 220a is positioned between the curtain plate 212 and the parallel plate electrodes 230 and may be coupled to a power source (e.g., power sources 204a,b or a separate power source (not shown)) such that various electrical signals may be applied to the jet injector plate 220a as discussed below. Though the jet injector electrode 220a is depicted as a single, plate electrode in FIG. 2, it will be appreciated that the housing inlet may also be comprised of two or more electrodes that are insulated from one another so as to form a multi-electrode inlet.

The jet injector electrode 220a may be sealingly engaged to the housing 220 so as to prevent the inflow of gas into or outflow of gas out of the analytical gap 232 other than through the aperture 222a or outlet 220b. To prevent voltages applied to the parallel plate electrodes 230 from also being applied to the jet injector electrode 220a, the jet injector electrode 220a may be electrically isolated from the parallel plate electrodes 230, for example, by an insulating material 224 as shown in FIG. 2. By way of non-limiting example, the jet injector electrode 220a may comprise a conductive plate, which may be braised to a non-conductive ceramic holder that forms the housing 220 and/or the front end of the parallel plate electrodes 230. The jet injector electrode 220a may also be fabricated from a non-conductive material such as ceramic with a conductive coating. Alternatively, the insulating material 224 may be replaced with a static air gap so long as the jet injector electrode 220a remains sealingly engaged to the housing 220 to prevent the flow of gas from the housing 220 other than through the jet injector aperture 222a or outlet 220b.

Though the aperture 222a of the jet injector electrode 220a can be any size or shape, certain aspects of the present teachings provide that the aperture 222a may exhibit a smaller area than the cross-sectional area of the analytical gap 232 to increase the transmission of ions entering the curtain plate opening 212a into the analytical gap 232 due to gas flow dynamics and/or ion funneling. For example, in some aspects, the jet injector electrode 220a can be operated at a DC potential similar or different from the parallel plate electrodes 230 to increase transmission through the aperture 222a by diminishing the divergent effect of the fringing fields experienced by ions after passing through the curtain plate opening 212a, which can result in ions impinging on the housing 220, for example. Moreover, a person skilled in the art would appreciate that ions entering the analytical gap 232 at a distance from the central axis may be more likely to be neutralized at the electrodes 230 due the effect of the CoV on their displacement from the central axis. That is, a combination of SV/CoV selected to transmit a particular ion species may nonetheless fail to transmit an ion of that species if the initial radial positioning of that ion as it enters the analytical gap 232 is too far off center. Without being bound by any particular theory, it is believed that the smaller aperture 222a (relative to the cross-section of the analytical gap 232) may direct ions more towards the center of the analytical gap 232 to improve the ions initial positioning due to the higher linear velocity of the gas flow resulting from the constriction, thereby potentially improving ion transfer through the electrodes 230. Additionally, in a multi-electrode inlet configuration, a supplemental periodic/harmonic RF/AC electric field may be generated between the inlet electrodes to further focus ions toward the center of the aperture 222a, thereby further increasing the efficiency of ion injection.

In accordance with various aspects of the present teachings, the size of the aperture 222a can be selected, for example, to control the residence time of ions within the analytical gap to adjust the selectivity of the system 200. By way of example, increasing the cross-sectional area of the inlet aperture 222a may be effective to slow down the linear velocity of the ions, thereby increasing the duration of time that ions are subjected to the differential mobility fields within the analytical gap 232. A person skilled in the art will appreciate in light of the present teachings, for example, that for a given volumetric flow rate (e.g., 10 L/min), the linear velocity of the ions and transport gas through the aperture 222a and analytical gap 232 decreases as the area of the aperture 222a increases. Likewise it will be appreciated that decreasing the area of the aperture 222a may decrease the residence time of ions within the analytical gap 232 as the linear velocity of the ions and transport gas increases for a given volumetric flow rate.

In some embodiments, the size of the aperture 222a may be selected, for example, by removing a first jet injector electrode 220a and substituting it with another jet electrode 220a having a differently-sized aperture. Additionally or alternatively, some aspects of the present teachings provide that the inlet of the housing 220 comprise an aperture 222a having a size that is capable of being adjusted in situ. Accordingly, rather than substituting various jet injector electrodes to achieve the desired residence time, the aperture 222a itself can be configured to be varied using an iris-diaphragm control system, by way of non-limiting example. It will be appreciated that iris-diaphragm flow control systems are similar in concept to the aperture system in a camera lens for controlling the amount of light entering the camera. In such aspects, the iris can comprise a plurality of fingers (e.g., three or more) arranged circumferentially around the flow path, which can be controlled to move into and out of the flow path to obstruct or unblock the flow of drift gas. Generally, the more fingers that are utilized, the more circular the aperture that is formed, but at the expense of increased complexity.

In certain aspects, the aperture 222a can exhibit an adjustable diameter that can be controlled to be in range between about 0.5 mm to about 20 mm (e.g., about 5 mm). The cross-sectional area of the aperture can be adjusted to be smaller than, greater than, or equivalent to the cross-sectional area of the analytical gap 232. For example, the aperture of 5 mm in diameter may exhibit a cross-sectional area approximately equal to the cross-sectional area of the analytical gap 232 where the gap height is 1 mm and gap width is 20 mm. In light of the above, systems in accordance with some aspects of the present teachings may utilize a relatively-small diameter aperture 222a to operate as an “ion scrubber” for transmitting a wide range of ions of interest with minimal losses (while unwanted ions are blocked), while a larger diameter aperture 222a may be used to provide “high resolution” analysis in which one or more particular species of ions of interest may be resolved from one another. Contrary to conventional knowledge, however, the systems described herein may provide for such increased selectivity without substantial effects on the transmission efficiency as peak resolution increases. Moreover, because systems and methods in accordance with the present teachings utilize drift gas volumetric flow rates substantially higher than those used in known DMS systems, the resulting increases in gas velocity may further reduce the exposure time of ions to the divergent fringing fields, thus further improving ion transmission.

### Examples

The surprising results of the applicant's teachings can be even more fully understood with reference to the following examples, which demonstrate that resolution can be unexpectedly enhanced without substantially diminished transmission efficiency for drift gas volumetric flow rates above about 10 L/min. It is intended that these examples be considered as exemplary only, and that other embodiments of the applicant's teachings will be apparent to those skilled in the art from consideration of the present specification and practice of the present teachings disclosed herein.

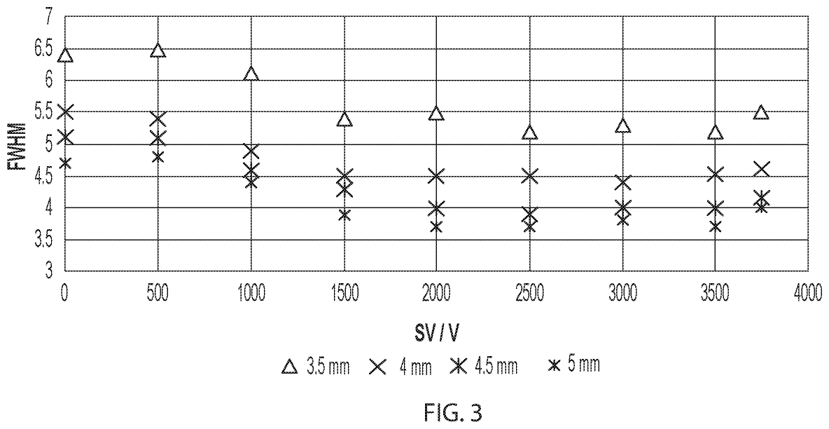

The performance of a differential mobility system as shown in FIG. 2 was tested with inlet apertures (e.g., aperture 222a) having diameters of 3.5 mm, 4.0 mm, 4.5 mm, and 5.0 mm at a drift gas volumetric flow rate of approximately 16 L/min. The DMS cell had 1 mm gap height, 20 mm width, and 63 mm length. The effect of these variously-sized apertures under various SV conditions on peaks widths are depicted in FIG. 3. Among these four configurations, the aperture having a diameter of 3.5 mm exhibited the widest peaks widths (e.g., FWHM˜5.5 V at SV=2000V), which progressively decreased as the diameter of the apertures increased. The aperture having a diameter of 5 mm resulted in the narrowest peak-width (e.g., FWHM˜3.7 V at SV=2000 V), thereby indicating enhanced resolution. This data suggests that as aperture size decreases in systems operated at elevated flow rates above 10 L/min, a stronger gas beam is generated, thus reducing the overall residence time and decreasing the resolution of the DMS analysis (i.e., broadening the peaks). To state another way, this data demonstrates that increasing the aperture size increases the residence time and increased the resolution.

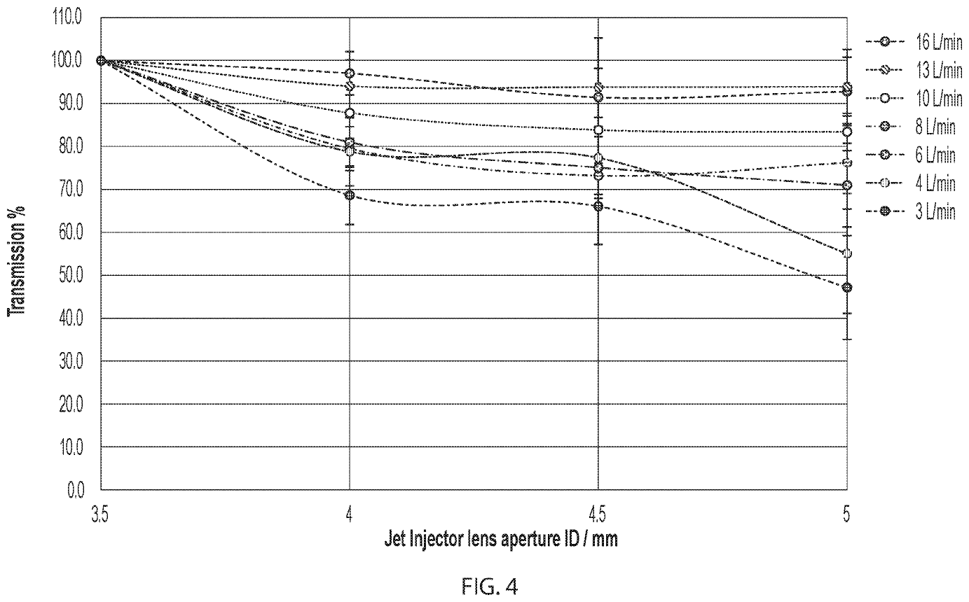

FIG. 4 depicts the average relative ion transmission of a mix of 21 different compounds through four differential mobility systems as shown in FIG. 2 having inlet aperture diameters of 3.5 mm, 4.0 mm, 4.5 mm, and 5.0 mm while the drift gas volumetric flow rates were varied from 3 L/min to 16 L/min. The data are also presented in the following table:

| | | Relative transmission | | | |
|---|---|---|---|---|---|
| | | (injector aperture diameter) | | | |
| Gas throughput | | 3.5 mm | 4.0 mm | 4.5 mm | 5.0 mm |
| 16 | L/min | 100.0 | 97.0 ± 5.0 | 91.4 ± 6.8 | 92.8 ± 8.0 |
| 13 | L/min | 100.0 | 94.1 ± 6.2 | 93.8 ± 11.5 | 93.9 ± 8.6 |
| 10 | L/min | 100.0 | 87.8 ± 5.9 | 83.8 ± 7.7 | 83.4 ± 4.3 |
| 8 | L/min | 100.0 | 79.5 ± 5.1 | 73.2 ± 4.4 | 76.2 ± 10.8 |
| 6 | L/min | 100.0 | 81.0 ± 5.9 | 75.1 ± 9.4 | 71.0 ± 9.7 |
| 4 | L/min | 100.0 | 78.8 ± 8.0 | 77.3 ± 9.4 | 55.0 ± 14.0 |
| 3 | L/min | 100.0 | 68.6 ± 6.8 | 66.0 ± 8.8 | 47.1 ± 12.1 |

While it was previously recognized in the art that increasing residence time in the DMS would likely result in increased resolution as discussed above with reference to FIG. 3, it was also commonly believed that such increases in residence time would result in diminished transmission efficiency due to the tradeoff between sensitivity and selectivity. As shown in FIG. 4 under conditions in which the drift gas flow was less than about 10 L/min, the transmission efficiency generally decreased as the aperture size increased in accordance with conventional thinking. However, under conditions in which the drift gas flow was at least about 10 L/min, FIG. 4 unexpectedly demonstrates that ion transmission was not substantially diminished as the aperture size and residence time increased. The data show that as the transport gas flow rate increased, the signal loss with a variable jet injector inlet diameter decreased substantially such that signal decreases less than 10% were measured with gas throughput greater than 10 L/min.

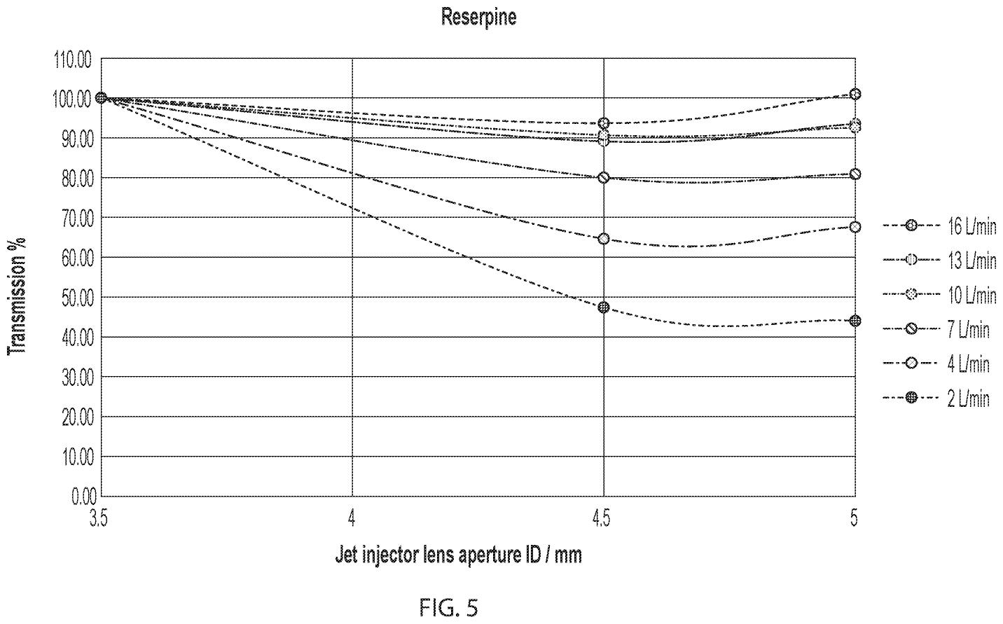

FIG. 5 depicts the results of the experiment of FIG. 4 solely for the compound reserpine. As shown, relative transmission of reserpine ions at an inlet aperture diameter of 5.0 mm was at least 90% of the intensity at 3.5 mm for each flow rate tested at 10 L/min or greater, while transmission was reduced to about 80%, 67%, and 45% at respective flow rate of 7 L/min, 4 L/min, and 2 L/min across the same inlet aperture decrease.

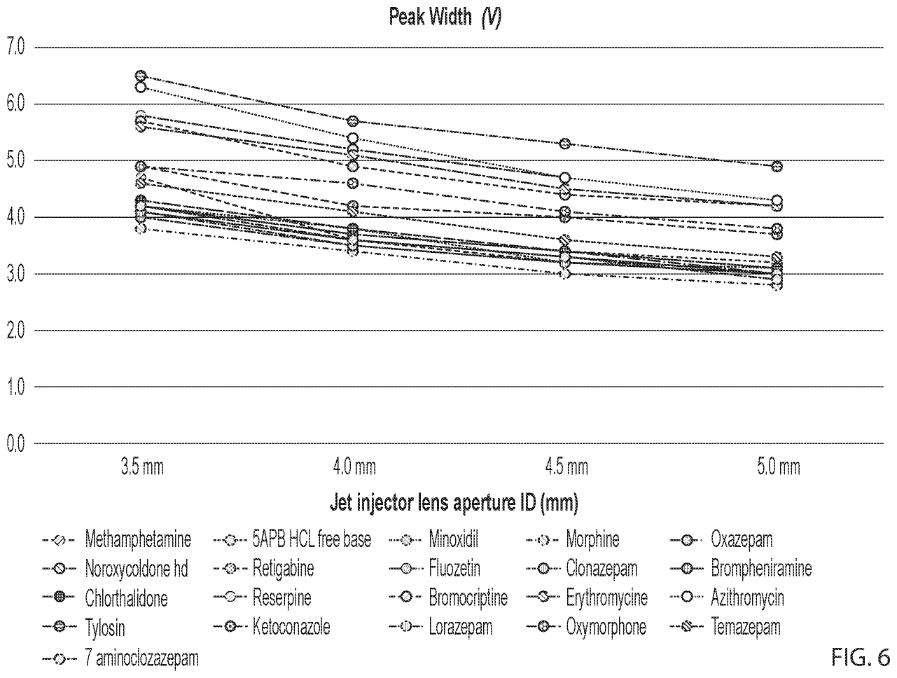

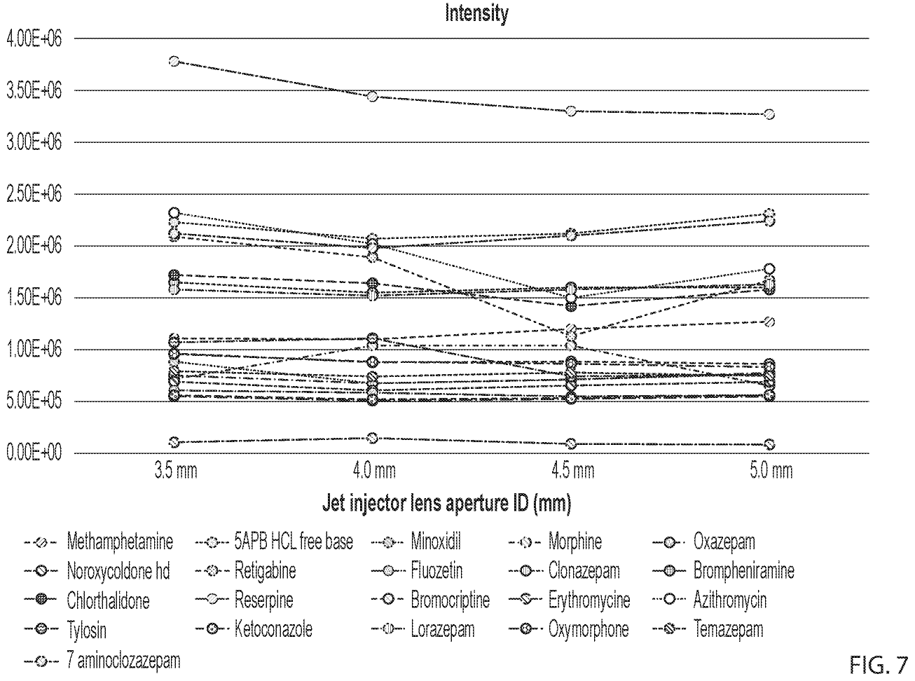

FIGS. 6 and 7 respectively depict the peak width and intensity of 21 different compounds that were transmitted through a differential mobility system similar to that of FIG. 2 and having inlet aperture diameters of 3.5 mm, 4.0 mm, 4.5 mm, and 5.0 mm with a drift gas volumetric flow rate of 16 L/min. Comparing FIGS. 6 and 7, it will be appreciated that at a drift gas flow rate of 16 L/min, the resolution increased (i.e., peak width decreased) while the transmission efficiency (i.e., intensity) remained substantially unchanged as the aperture size increased for most compounds. The data are also presented in the following table:

| | | | 3.5 mm | | 4.0 mm | | 4.5 mm | | 5.0 mm | |
|---|---|---|---|---|---|---|---|---|---|---|
| Gas throughput = 16 L/min | | | | peak | | peak | | peak | | peak |
| ID | Q1 | Q3 | intensity | width | intensity | width | intensity | width | intensity | width |
| Methamphetamine | 150.4 | 91.0 | 1.11E+06 | 4.7 | 1.10E+06 | 3.6 | 1.20E+06 | 3.2 | 1.27E+06 | 3.0 |
| SAPB HCL free base | 176.3 | 159.1 | 2.23E+06 | 4.0 | 2.07E+06 | 3.5 | 2.12E+06 | 3.2 | 2.31E+06 | 3.0 |
| Minoxidil | 210.2 | 193.1 | 8.85E+05 | 4.2 | 6.76E+05 | 3.8 | 7.12E+05 | 3.2 | 7.66E+05 | 3.1 |
| Morphine | 285.7 | 152.2 | 7.17E+05 | 3.8 | 1.04E+06 | 3.4 | 1.04E+06 | 3.0 | 6.53E+05 | 2.8 |
| Oxazepam | 286.7 | 241.2 | 7.53E+05 | 4.0 | 6.75E+05 | 3.5 | 7.12E+05 | 3.2 | 7.77E+05 | 3.0 |
| Noroxycoldone hcl | 301.7 | 187.1 | 6.92E+05 | 4.1 | 6.07E+05 | 3.6 | 6.54E+05 | 3.3 | 6.90E+05 | 3.0 |
| Retigabine | 303.7 | 109.0 | 2.09E+06 | 4.3 | 1.89E+06 | 3.8 | 1.13E+06 | 3.4 | 1.67E+06 | 3.2 |
| Fluoxetin | 309.7 | 91.1 | 6.08E+05 | 4.2 | 5.85E+05 | 3.7 | 5.49E+05 | 3.4 | 5.63E+05 | 3.1 |
| Clonazepam | 316.6 | 270.1 | 1.65E+06 | 4.1 | 1.55E+06 | 3.6 | 1.60E+06 | 3.3 | 1.60E+06 | 3.0 |
| Brompheniramine | 319.6 | 275.0 | 5.51E+05 | 4.2 | 5.08E+05 | 3.7 | 5.26E+05 | 3.4 | 5.50E+05 | 3.0 |
| Chlorthalidone | 338.6 | 322.0 | 1.72E+06 | 4.3 | 1.64E+06 | 3.8 | 1.42E+06 | 3.4 | 1.58E+06 | 3.1 |
| Reserpine | 609.3 | 195.0 | 3.78E+06 | 5.8 | 3.44E+06 | 5.2 | 3.30E+06 | 4.7 | 3.27E+06 | 4.3 |
| Bromocriptine | 654.0 | 346.1 | 9.64E+05 | 5.7 | 8.78E+05 | 4.9 | 8.87E+05 | 4.4 | 8.63E+05 | 4.2 |
| Erythromycine | 733.9 | 158.1 | 1.07E+05 | 5.6 | 1.48E+05 | 5.1 | 9.22E+04 | 4.5 | 8.54E+04 | 4.2 |
| Azithromycin | 748.8 | 591.4 | 2.32E+06 | 6.3 | 2.02E+06 | 5.4 | 1.50E+06 | 4.7 | 1.78E+06 | 4.3 |
| Tylosin | 915.0 | 174.1 | 1.07E+06 | 6.5 | 1.11E+06 | 5.7 | 7.43E+05 | 5.3 | 7.57E+05 | 4.9 |
| Ketoconazole | 531.4 | 489.0 | 5.61E+05 | 4.9 | 5.21E+05 | 4.2 | 5.33E+05 | 4.0 | 5.63E+05 | 3.7 |
| Lorazepam | 321.4 | 275.1 | 1.58E+06 | 4.1 | 1.52E+06 | 3.5 | 1.58E+06 | 3.2 | 1.63E+06 | 3.0 |
| Oxymorphone | 302.5 | 284.1 | 9.58E+05 | 4.9 | 8.84E+05 | 4.6 | 8.64E+05 | 4.1 | 8.32E+05 | 3.8 |
| Temazepam | 301.5 | 255.2 | 7.94E+05 | 4.6 | 7.41E+05 | 4.1 | 7.81E+05 | 3.6 | 7.46E+05 | 3.3 |
| 7 aminoclonazepam | 286.7 | 222.2 | 2.12E+06 | 4.2 | 1.98E+06 | 3.6 | 2.10E+06 | 3.3 | 2.24E+06 | 2.9 |
| | | Avg peak | | 4.7 | | 4.1 | | 3.7 | | 3.4 |
| | | widths | | | | | | | | |

Together, FIGS. 3-7 demonstrate the substantial and unforeseen ability to achieve adjustable peak widths (resolution) without substantial loss of transmission when operating at volumetric gas flow rates greater than about 10 L/min through the DMS cell. Without being bound by any particular theory, it is believed that such elevated volumetric flow rates increase drift gas velocity sufficient to reduce the exposure to the entrance fringing fields of the DMS electrodes, thus reducing ion losses. It will be apparent to those of skill in the relevant arts that maintaining near maximum transmission at high resolution is a major benefit over previous DMS devices with low gas throughput. Under some conditions, this could eliminate the need for adjustable resolution (i.e. maintain high resolution all the time since there is no significant transmission penalty).

The section headings used herein are for organizational purposes only and are not to be construed as limiting. While the applicant's teachings are described in conjunction with various embodiments, it is not intended that the applicant's teachings be limited to such embodiments. On the contrary, the applicant's teachings encompass various alternatives, modifications, and equivalents, as will be appreciated by those of skill in the art.

What is claimed is:

1. A method of analyzing ions in a differential mobility spectrometer, comprising:
introducing a drift gas at a flow rate greater than about 10 L/min through an inlet of a differential mobility spectrometer;
performing differential mobility separation on ions within the drift gas using the differential mobility spectrometer as the drift gas transports the ions therethrough.

2. The method of claim 1, further comprising adjusting a resolution of the differential mobility separation for at least one species of ion of interest without substantially adjusting transmission of said at least one species of ion of interest.

3. The method of claim 2, wherein the flow rate of the drift gas through the inlet is substantially maintained during said adjusting step.

4. The method of claim 2, wherein a throttle gas is not provided to an outlet of said differential mobility spectrometer during said adjusting step.

5. The method of claim 1, further comprising adjusting a cross-sectional area of the inlet to adjust a residence time of ions within the differential mobility spectrometer.

6. The method of claim 1, further comprising adjusting a diameter of the inlet to be in a range of between about 0.5 mm and about 20 mm.

7. (canceled)

8. The method of claim 1, wherein the differential mobility spectrometer comprises parallel plate electrodes separated by an analytical gap, and wherein the inlet is adjustable relative to the cross-sectional area of the analytical gap.

9. The method of claim 1, wherein the flow rate of drift gas through the inlet is in a range of about 10 L/min to about 30 L/min.

10. The method of claim 1, wherein an outlet of the differential mobility spectrometer is sealed to an inlet of a vacuum chamber containing at least one mass spectrometer, the method further comprising performing mass spectrometry on ions transported through the outlet of the differential mobility spectrometer into the inlet of the mass spectrometer.

11. The method of claim 10, further comprising adjusting a resolution of the differential mobility separation for at least one species of ion of interest by adding or removing gas between the outlet of the differential mobility spectrometer and the inlet of the vacuum chamber containing the at least one mass spectrometer.

12. A system comprising:
a housing having an inlet and an outlet;
at least two parallel plate electrodes disposed within said housing and separated from one another by a fixed distance, the volume between the two electrodes defining an analytical gap through which ions are transported from the inlet toward the outlet;
a voltage source for providing RF and DC voltages to at least one of the parallel plate electrodes to generate an electric field, the electric field for passing through selected ions species based on mobility characteristics; and
a drift gas supply for supplying a gas that flows through the inlet at a flow rate greater than about 10 L/min.

13. The system of claim 12, wherein the inlet comprises an aperture for allowing the traversal of the drift gas into the housing, and wherein a cross-sectional area of the aperture is adjustable.

14-16. (canceled)

17. The system of claim 13, wherein a diameter of the inlet is adjustable between about 0.5 mm and about 20 mm.

18. The system of claim 13, wherein the aperture extends through at least one electrode plate, wherein the at least one electrode plate is electrically separated from the parallel plate electrodes.

19. The system of claim 12, wherein a throttle gas supply is not provided for adding a throttle gas to the outlet of the housing.

20. The system of claim 12, wherein a throttle gas supply is provided for adding a throttle gas to the outlet of the housing, and wherein adjustments to the throttle gas are configured to modify residence time within the differential mobility spectrometer.

21. (canceled)

22. The system of claim 12, wherein the cross-sectional area of the analytical gap is about 20 mm², or wherein a length of the analytical gap along the direction of drift gas flow is greater than about 30 mm.

23. (canceled)

24. The system of claim 12, wherein the outlet is sealed to an inlet of a vacuum chamber containing at least one mass spectrometer.

25. The system of claim 12, further comprising:
a curtain chamber within which the housing is disposed; and
a curtain gas supply for providing a flow of curtain gas into the curtain chamber, wherein the curtain gas flow is provided at a flow rate greater than the flow rate of the drift gas flow rate, or wherein a portion of the curtain gas outflows from an aperture in the curtain plate and the remainder forms the drift gas.

26. (canceled)

27. The system of claim 12, wherein the drift gas comprises at least one of a chemical modifier and a mixture of gases.
